(19) United States
(12) Patent Application Publication
(10) Pub. No.: US 2020/0198551 A1
(43) Pub. Date: Jun. 25, 2020

(54) Vehicle Part Having a Layered Decorative Finish with a Logo, Design or Emblem Exposed at the Front of the Part

(71) Applicant: Global IP Holdings, LLC, Sterling Heights, MI (US)

(72) Inventors: Scott Allen Grajek, Washington Township, MI (US); Jesse Brian Straight, Dacula, GA (US); Dustin Martin Fowler, Dacula, GA (US); Shane Caird Morse, Grosse Pointe Farms, MI (US)

(73) Assignee: Global IP Holdings, LLC, Sterling Heights, MI (US)

(21) Appl. No.: 16/224,892

(22) Filed: Dec. 19, 2018

(51) Int. Cl. B60R 13/00; B29C 70/86; B29C 70/42; B62D 25/08

(52) U.S. Cl. CPC B60R 13/005; B29C 70/865; B29L 2031/722; B62D 25/088; B62D 25/082; B29C 70/42

(57) ABSTRACT

A vehicle part having a layered, decorative finish is provided. The part includes a substrate of woven fiber prepreg sheet, a first layer of woven fiber prepreg sheet overlying the substrate and a decorative layer of unidirectional fiber prepreg sheet overlying the substrate. A front surface of the decorative layer includes a logo, design or emblem which is exposed at the front of the part.

### TECHNICAL FIELD

At least one embodiment of the present invention generally relates to vehicle parts having a layered decorative finish and, in particular, to such parts which have a logo, design or emblem exposed at the front of the part.

### OVERVIEW

Composite materials are typically made from two or more constituent materials with significantly different physical or chemical properties. Typically, the constituent materials include a matrix (or bond) material, such as resin (e.g., thermoset epoxy), and a reinforcement material, such as a plurality of fibers (e.g., woven layer of carbon fibers). When combined, the constituent materials typically produce a composite material with characteristics different from the individual constituent materials even though the constituent materials generally remain separate and distinct within the finished structure of the composite material. Carbon-fiber reinforced polymer (CFRP) is an example of such a composite material.

One method of producing CFRP parts or panels is by layering sheets of carbon fiber cloth or fabric into a mold in the shape of the final product. The alignment and weave of the cloth fibers is chosen to optimize the strength and stiffness properties of the resulting material. The mold is then filled with epoxy and is heated or air-cured. The resulting part is very corrosion-resistant, stiff, and strong for its weight. Parts used in less critical areas are manufactured by draping cloth over a mold, with epoxy either preimpregnated into the fibers (also known as pre-preg) or “painted” over it. High-performance parts using single molds are often vacuum-bagged and/or autoclave-cured, because even small air bubbles in the material will reduce strength. An alternative to the autoclave method is to use internal pressure via inflatable air bladders or EPS foam inside the non-cured laid-up carbon fiber.

Composite materials may be preferred for many reasons. For example, composite materials may be stronger and/or lighter than traditional materials. As a result, composite materials are generally used to construct various objects such as vehicles (e.g., airplanes, automobiles, boats, bicycles, and/or components thereof), and non-vehicle structures (e.g., buildings, bridges, swimming pool panels, shower stalls, bathtubs, storage tanks, and/or components thereof).

U.S. Patent documents 2005/0255311 and 2018/0085991 disclose a wide variety of motor vehicle parts made of carbon fiber composites.

As described in U.S. Pat. No. 7,513,515, one of the most common upgrades on a modified car is mounting strut bars. A strut bar (also known as strut tower brace (STB) or strut brace) is designed to tie the two opposing strut towers together as a single solid unit. The purpose of a strut bar is to reduce flex these strut towers experience during hard cornering. When taking a turn a car's strut towers normally flex, resulting in body-flex and loss of traction. Consequently, strut bars are designed to keep strut towers from flexing, in that the strut bars take the pressure being applied to one strut tower when taking a turn and distributing that pressure to both strut towers.

This is so because a strut bar is constructed to tie the two strut towers of a car together so that they share the load applied as the outer strut tower. This accords twice as much material [i.e., strut towers] when a strut tower encounters the same cornering forces and helps reduce fatigue stress in this area by “sharing” the forces. This tying [connecting] together of two opposing strut towers reduces a vehicle's chassis flex and body flex. And, as so connected, as a single solid unit, it provides for added stiffness and transmits the load of each strut tower during cornering via tension and compression of the strut bar which shares the load between both strut towers and thereby reduces chassis flex.

Because the tops of such strut towers on cars sit high in the engine compartment, a typical strut bar is a basically linear piece attached to the tops of the struts tying the two together. U.S. Pat. No. 8,668,212 discloses a stabilizer bar of fiber reinforced plastic composite.

It is often desirable to provide a logo or design on the surface of a molded automotive part which is visible during use of the vehicle. Previous methods required the logo/design to be applied post-molding and, in most cases, after paint is applied to the part. This results in increased cost/labor and the possibility of damaging material late in the process cycle.

### SUMMARY OF EXAMPLE EMBODIMENTS

An object at least one embodiment of the present invention is to provide a vehicle part such as a vehicle strut tower brace (STB) having a logo/design incorporated therein during a composite molding process used in manufacturing the part. The materials used in the process are of either the same construction or of different construction in order to create a noticeable difference that defines the logo/design.

In carrying out the above object and other objects of at least one embodiment of the present invention, a vehicle part having a layered, decorative finish is provided. The part includes a substrate of woven fiber prepreg sheet, a first layer of woven fiber prepreg sheet overlying the substrate and a decorative layer of unidirectional fiber prepreg sheet overlying the substrate. A front surface of the decorative layer includes a logo, design or emblem which is exposed at the front of the part.

The first layer and the decorative layer may define the logo, design or emblem.

The part may further include a veneer layer of woven fiber prepreg sheet wherein the substrate may overlie the veneer layer.

The fiber of each of the layers and the substrate may be carbon.

The decorative layer may be in contact with the substrate.

The first layer may be in contact with the substrate.

The substrate may be in contact with the veneer layer at a lower surface of the substrate.

The logo, design or emblem may be bookmatched.

The part may further include a protective layer overlying and protecting the decorative layer. The protective layer may seal the front surface of the decorative layer thereby protecting the logo, design or emblem.

The protective layer may comprise a clear top coat layer.

The first layer may have an opening extending from a front surface of the first layer to a rear surface of the first layer. A cross-section of the opening at the front surface of the first layer may be sized and shaped to form the logo, design or emblem which is exposed at the front of the part.

The part may be a vehicle strut tower brace (STB).

### BRIEF DESCRIPTION OF THE DRAWINGS

FIG. 1 is an environmental view, partially broken away, of a vehicle strut tower brace (STB) mounted in the engine compartment of the vehicle;

FIG. 2 is an enlarged top perspective view of the STB of FIG. 1;

FIG. 3 is an enlarged view of a bookmatched portion of the STB of FIGS. 1 and 2 and which show a logo/design;

FIG. 4 is a view similar to the view of FIG. 3 except the portion is not bookmatched inside the logo/design;

FIG. 5 is a view similar to the views of FIGS. 3 and 4 wherein the areas within the logo/design are bookmatched;

FIG. 6 is a view similar to the views of FIGS. 3, 4 and 5 wherein there is no bookmatch inside the logo/design;

FIG. 7A is a side sectional view of the STB constructed in accordance with one embodiment of the invention wherein a logo/design is exposed via a clear top coat layer on unidirectional, logo material of the layered part; and

FIG. 7B is a view similar to the view of FIG. 7A but apportion of a 3K layer is removed to expose the logo/design via the unidirectional, logo material.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As used in this application, the term “substrate” refers to any flexible, semi-flexible or rigid single or multi-layer component having a surface to which a layer is or can be applied by the methods described herein such as, without limitation, polymers and other plastics, as well as composite materials. Furthermore, the shape of the substrate and particularly the surface to be layered can be any part of an assembly or device manufactured by any of various methods, such as, without limitation, conventional composite molding. One preferred application contemplated herein is the layering of substrates that are automotive components such as strut tower braces.

The term “overlies” and cognate terms such as “overlying” and the like when referring to the relationship of one or a first, superjacent layer relative to another or a second, subjacent layer, means that the first layer partially or completely lies over the second layer. The first, superjacent layer overlying the second, subjacent layer may or may not be in contact with the subjacent layer, one or more additional layers may be positioned between respective first and second, or superjacent and subjacent, layers.

In the automotive industry, it is common practice to refer to various surfaces as being A-, B-, or C-surfaces. As used herein, the term “A-surface” refers to an outwardly facing surface for display in the interior of a motor vehicle such as an engine compartment. This surface is a high visibility surface of the vehicle that is most important to the observer or that is most obvious to the direct line of vision. With respect to motor vehicle interiors, examples include dashboards, instrument panels, steering wheels, head rests, upper seat portions, headliners, load floors and pillar coverings.

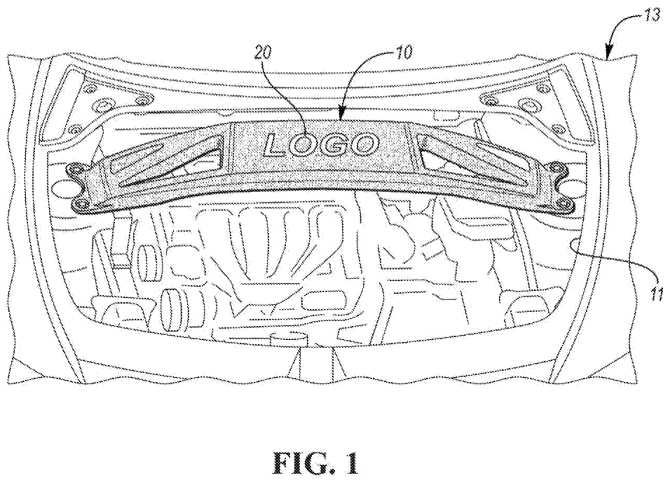

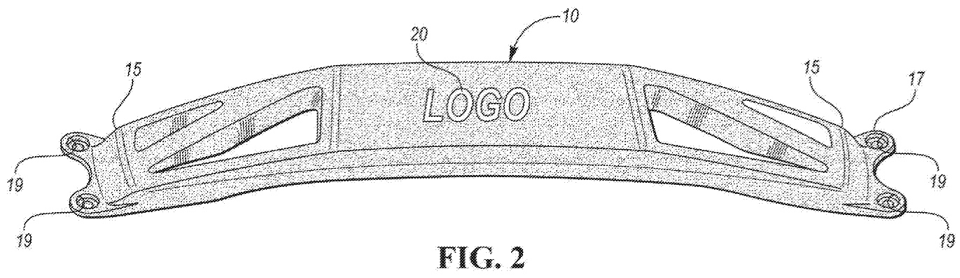

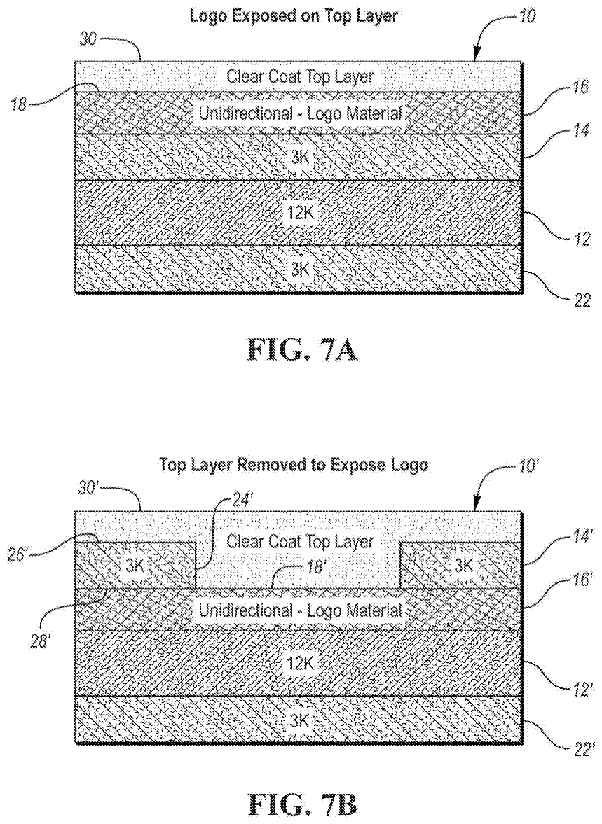

A vehicle strut tower brace (STB) constructed in accordance with at least one embodiment of the present invention has a layered, decorative finish and is generally indicated at 10 in FIGS. 1 and 2. Referring to FIG. 7A, the brace 10 includes a substrate 12 of woven fiber prepreg sheet, a first layer 14 of woven fiber prepreg sheet overlying the substrate 12 and a decorative layer 16 of unidirectional fiber prepreg sheet overlying the substrate 12. A front surface 18 of the decorative layer 16 includes a logo, design or emblem 20 which is exposed at the front of the brace 10.

Referring to FIG. 7B, a brace 10′ of a second embodiment of the invention is illustrated wherein the same or similar parts to the parts of the first embodiment have the same reference number but a single prime designation.

The STB 10 (and the STB 10′) is preferably compression molded and is preferably formed by four plies or layers of fiber-reinforced composite material such as carbon-fiber reinforced plastic (CFRP). Each of the plies is preferably a woven mat of carbon fibers in an epoxy resin matrix. Two plies are 3K “veneer” plies, the logo material is a unidirectional plie and the middle ply is a 12K “structural” or substrate plie. The fibers are collected into thread-like bundles called “tows” which are wound onto large bobbins. Standard tow sizes are 1K, 3K, 6K, and 12K. The K designation means “thousands of filaments per tow.” For example, a 3K fabric has 3,000 carbon fiber filaments per tow and a 6K fabric has 6,000 filaments per tow. The weaver loads the tows onto a loom where they are woven into a fabric. The most common forms of fabric are:
Woven (plain weave, twill, satin)
Unidirectional, Multidirectional (biaxial, triaxial, quasi-isotropic)
Nonwoven (chopped or continuous strand mats)

The first layer 14′ and the decorative layer 16′ may define the logo, design or emblem 20 as shown in FIG. 7B.

The brace 10 may further include a veneer layer 22 of woven fiber prepreg sheet wherein the substrate 12 overlies the veneer layer 22. In like fashion, the brace 10′ may further include a veneer layer 22′ of woven fiber prepreg sheet.

The fibers of each of the layers 14, 16, 22 (and the layers 14′, 16′ and 22′) and the substrate 12 (and the substrate 12′) may be carbon.

The decorative layer 16′ may be in contact with the substrate 12′ as shown in FIG. 7B.

The layer 14 may be in contact with the substrate 12 as shown in FIG. 7A.

The substrate 12 (and the substrate 12′) may be in contact with the veneer layer 22 (and the veneer layer 22′) at a lower surface of the substrate 12 and 12′, respectively.

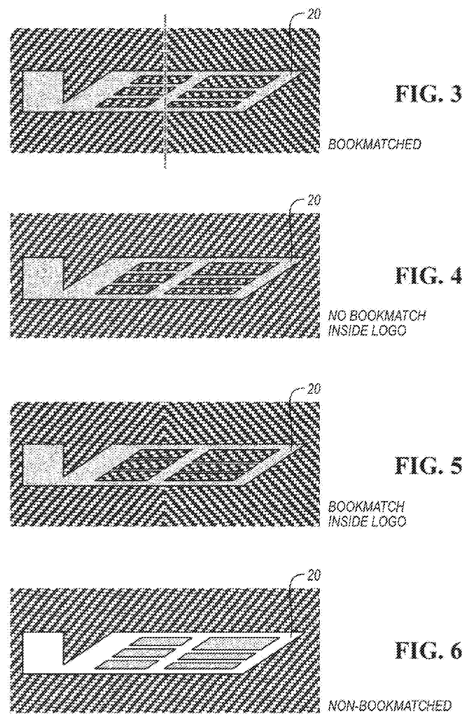

The logo, design or emblem 20 may be bookmatched as shown in FIGS. 3 and 5 or non-bookmatched as shown in FIGS. 4 and 6.

The first layer 14′ may have an opening 24′ extending from a front surface 26′ of the first layer 14′ to a rear surface 28′ of the first layer 14′. A cross-section of the opening 24′ at the front surface 26′ of the first layer 14′ is sized and shaped to form the logo, design or emblem 20 which is exposed at the front of the brace 10′.

As shown in FIG. 7A, the brace 10 may further include a protective layer 30 overlying and protecting the decorative layer 16. The protective layer 30 seals the front surface 18 of the decorative layer 16 thereby protecting the logo, design or emblem 20. In like fashion, as shown in FIG. 7B, the brace 10′ typically includes a protective layer 30′.

The protective layer 30 may comprise a clear top coat layer. The clear top coat layer 30 (and the layer 30′) overlies and protects the decorative layer 16 (and the layer 16′). The layer 30 may be a transparent or translucent plastic such as polycarbonate, acrylic, ABS, plexiglass, lexant; polypropylene, poly (methyl methacrylate), thermoplastic urethane, polyester, copolyester alloy, cyclic olefin copolymer, poly-4-methyl-1-pentene, polysulphone, allyl diglycol carbonate, allyl ester, styrene-acrylonitrile, polystyrene, polyvinyl chloride and blends, alloys and combinations thereof. The layer 30 may include one or more pigments, tints, colored dyes, metallic flakes or light reflective particles therein. The layer 30 may include one or more anti-fading components, one or more anti-soiling components and one or more water-repellant compounds.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle part having a layered, decorative finish, the part comprising:
a substrate of woven fiber prepreg sheet;
a first layer of woven fiber prepreg sheet overlying the substrate; and
a decorative layer of unidirectional fiber prepreg sheet overlying the substrate wherein a front surface of the decorative layer includes a logo, design or emblem which is exposed at the front of the part.

2. The part as claimed in claim 1 wherein the first layer and the decorative layer define the logo, design or emblem.

3. The part as claimed in claim 1 further comprising a veneer layer of woven fiber prepreg sheet wherein the substrate overlies the veneer layer.

4. The part as claimed in claim 3 wherein the fiber of each of the layers and the substrate is carbon.

5. The part as claimed in claim 1 wherein the decorative layer is in contact with the substrate.

6. The part as claimed in claim 1 wherein the first layer is in contact with the substrate.

7. The part as claimed in claim 3 wherein the substrate is in contact with the veneer layer at a lower surface of the substrate.

8. The part as claimed in claim 1 wherein the logo, design or emblem is bookmatched.

9. The part as claimed in claim 1 further comprising a protective layer overlying and protecting the decorative layer, the protective layer sealing the front surface of the decorative layer thereby protecting the logo, design or emblem.

10. The part as claimed in claim 9 wherein the protective layer comprises a clear top coat layer.

11. The part as claimed in claim 1 wherein the first layer has an opening extending from a front surface of the first layer to a rear surface of the first layer wherein a cross-section of the opening at the front surface of the first layer is sized and shaped to form the logo, design or emblem which is exposed at the front of the part.

12. A vehicle strut tower brace (STB) having a layered, decorative finish, the brace comprising:
a substrate of woven fiber prepreg sheet;
a first layer of woven fiber prepreg sheet overlying the substrate; and
a decorative layer of unidirectional fiber prepreg sheet overlying the substrate wherein a front surface of the decorative layer includes a logo, design or emblem which is exposed at the front of the brace.

13. The brace as claimed in claim 12 wherein the first layer and the decorative layer define the logo, design or emblem.

14. The brace as claimed in claim 12 further comprising a veneer layer of woven fiber prepreg sheet wherein the substrate overlies the veneer layer.

15. The brace as claimed in claim 14 wherein the fiber of each of the layers and the substrate is carbon.

16. The brace as claimed in claim 12 wherein the decorative layer is in contact with the substrate.

17. The brace as claimed in claim 12 wherein the first layer is in contact with the substrate.

18. The brace as claimed in claim 14 wherein the substrate is in contact with the veneer layer at a lower surface of the substrate.

19. The brace as claimed in claim 12 wherein the logo, design or emblem is bookmatched.

20. The brace as claimed in claim 12 further comprising a protective layer overlying and protecting the decorative layer, the protective layer sealing the front surface of the decorative layer thereby protecting the logo, design or emblem.

21. The brace as claimed in claim 20 wherein the protective layer comprises a clear top coat layer.

22. The brace as claimed in claim 12 wherein the first layer has an opening extending from a front surface of the first layer to a rear surface of the first layer wherein a cross-section of the opening at the front surface of the first layer is sized and shaped to form the logo, design or emblem which is exposed at the front of the brace.
